(19) United States
(12) Patent Application Publication
(10) Pub. No.: US 2015/0215790 A1
(43) Pub. Date: Jul. 30, 2015

(54) ASSEMBLING A DATABASE OF SMALL CELL INFORMATION

(71) Applicant: SOLUTELIA, LLC., Aurora, CO (US)

(72) Inventors: Mohssen DAVARI, Denver, CO (US); Youn-Jung HAN, Seoul (KR); Myung-Chul KIM, Gwangju-si (KR)

(73) Assignee: SOLUTELIA, LLC., Aurora, CO (US)

(21) Appl. No.: 14/164,984

(22) Filed: Jan. 27, 2014

(51) Int. Cl. H04W 16/18; H04W 8/20

(52) U.S. Cl. CPC H04W 16/18; H04W 8/20

(57) ABSTRACT

A database of small cell information for use in mobile wireless communication network design and optimization is assembled using information received from a user mobile communication device. The user mobile communication device creates a new database entry including an identifier of a macro cell with which the device is associated, and an identifier of a location of the device. The database entry further includes user inputted information. The assembled information is transmitted from the device to the database for storage in a new entry. In response to receiving the assembled information, the database can transmit the information to a console for review. A user of the console can issue a command associated with the database entry which is transmitted via the database to the user mobile communication device. The command can be a revision of information in the entry, or a control command to capture a picture, for example.

### TECHNICAL FIELD

The present subject matter relates to techniques and equipment for assembling a database of small cell information for use in mobile wireless communication network design and optimization.

### BACKGROUND

Mobile wireless communication networks enable mobile subscribers to make and receive telephone calls, and to transmit and receive data using mobile communications devices such as cellular phones and smartphones. When a mobile communication device is used in the vicinity of a base station and a clear communication link is available between the mobile device and the base station, the mobile device may be provided with high reliability and high quality mobile communication services. However, when many mobile communications devices are crowded in the vicinity of a base station, or when a mobile device is located in a radio shadow area of the base station, communications between mobile devices and base stations may suffer from slow and/or unreliable service.

To provide high quality mobile communication services, mobile wireless communication network operators enhance the quality of their networks by installing additional base stations or repeaters to provide expanded network coverage and to handle increasing numbers of mobile devices. Prior to installing additional base stations and repeaters, however, the network operators must identify locations in which to install the additional equipment so as to improve the quality of network services.

The identification of locations in which to install additional equipment can include identifying areas in which the quality of a wireless communication network is poor, such as a radio shadow area. In general, the measurement of the quality of a wireless communication network is undertaken by highly trained persons having received education related to the measurement of the quality of wireless communications networks and using specialized devices intended for use by such experts. As a result, mobile network operators incur significant expense to obtain such measurements.

A need therefore exists for more versatile systems and methods for identifying areas in which the quality of a wireless communication network is poor and identifying within these areas specific locations to install additional equipment to improve quality of service. A need therefore exists for enabling network operators to readily obtain information on areal locations susceptible to improved network quality, and for identifying optimal locations within the areal locations for installing additional equipment to improve quality of the network.

### SUMMARY

According to an aspect of the present application, a method is provided for assembling a database of small cell information for use in design and optimization of a mobile wireless communication network. In accordance with the method, a request to create a new database entry for storing small cell information is received in a user mobile communication device communicatively coupled to the database through the mobile wireless communication network. The database stores a plurality of database entries each including small cell information on a location for installing small cell equipment. In response to receiving the request, a macro cell of the mobile wireless communication network that the user mobile communication device is currently associated with or was most recently associated with is automatically identified. Additionally, a current location of the user mobile communication device is automatically identified via a location determination system. A user of the user mobile communication device is prompted to input additional information to store in the new database entry and relating to a location for installing small cell equipment. Finally, the request to create the new database entry storing the identified macro cell, the identified current location, and additional information obtained from the user in response to the prompt is transmitted from the user mobile communication device to the database.

According to another aspect of the present application, a method is provided for assembling a database of small cell information for use in mobile communication network design and optimization. In accordance with the method, small cell information is received in a database server storing the database from a user mobile communication device communicatively coupled through the mobile communication network. The small cell information includes information on a location for installing small cell equipment. In response to the receiving of the small cell information, the received small cell information is stored in a small cell database entry of the database. A communication including the small cell information is transmitted from the database server to a console communicatively coupled to the database server. Further, a command from a user of the console is received in the database server from the console, wherein the command is associated with the small cell database entry. In response to receiving the command, a user mobile communication device associated with the small cell database entry is identified, and the command is forwarded from the database server to the identified user mobile communication device.

These general and specific aspects may be implemented using a system, a method, or a computer program, or any combination of systems, methods, and computer programs. Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a high-level functional block diagram schematically illustrating coverage areas of a mobile wireless communication network having a plurality of base stations and low-power access nodes.

FIG. 2 is a block diagram of a system for assembling a database of small cell information for use in mobile wireless communication network design and optimization.

FIGS. 3A-3E are screenshots illustrating the operation of a database application executing on a mobile communication device during the creation of a new database entry.

FIGS. 4A-4D are screenshots illustrating the operation of a database or console application executing on a mobile communication device or a console during the retrieval of information from the database.

FIGS. 5A and 5B are flow diagrams illustrating steps performed by the database, and by a user mobile communication device and/or a console, in assembling and using the database.

FIGS. 6, 7, and 8 are high-level functional block diagrams of an exemplary user mobile communication device, an exemplary database and database server, and an exemplary console, respectively, as may be involved in the assembly and use of the database of small cell information.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various systems and methods disclosed herein relate to assembling a database of small cell information for use in mobile communication network design and optimization.

In accordance with the disclosure, a user mobile communication device such as a smartphone is operative to gather information on candidate small cell locations and on actual small cell locations, and to upload the gathered information through a mobile communication network to a small cell information database. In particular, the user mobile communication device executes a small cell database application configured to automatically gather small cell information as well as to receive user inputted small cell information. For example, location information (e.g., GPS coordinates) and mobile communication network connectivity information (e.g., a cell ID) can be automatically obtained by the application by accessing appropriate systems of the mobile communication device. The application can additionally obtain pictures of the cell location, of a surrounding environment of the cell location, and/or of small cell equipment (e.g., in the case of an actual small cell location) using a camera of the mobile communication device. A user can provide other small cell information such as information on a surrounding environment of a cell location into the application for upload to the database. The small cell information obtained through the application is uploaded to the small cell information database for use by a user of the mobile communication device and/or other users of the database.

In turn, the information uploaded into the small cell information database is used to provide network design and optimization information. The database information can be used by the user of the small cell database application executing on the user mobile communication device to obtain small cell information. The database information can also be used by a user of a console executing on a server or other computing device to obtain small cell information. In either instance, the user causes a small cell information request to be transmitted to the database. The request can include a location, cell ID, or other search criteria for identifying small cells of interest to the user. In response to receiving the request, the database is searched and small cell information matching the request's search criteria is returned for the user. The user may modify the small cell information and upload the modified information back to the database.

Once the database of small cell information is assembled, a user can use the information stored in the database to run various simulations and/or network analyses. For example, the user may use the information stored in the database to identify and select an optimal location, or an optimal set of locations, for installing new small cell equipment. The user may use the database to simulate the expected performance of the network at various locations under the assumption that small cell equipment is installed in, and/or removed from, selected locations. The user may further use the database to simulate the expected performance of the network at various locations under different load conditions (e.g., when large numbers of mobile communication devices are located at the locations and use network resources).

Reference now is made in detail to the examples illustrated in the accompanying drawings and discussed below.

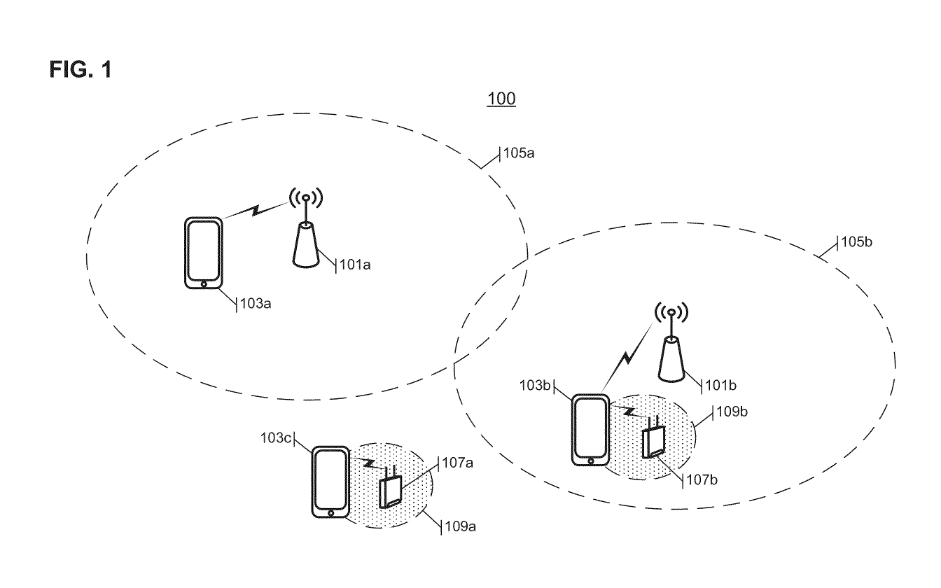

FIG. 1 schematically illustrates coverage areas of a mobile wireless communication network 100 having a plurality of base stations 101a, 101b. The mobile wireless communication network 100 provides mobile communication services, including voice and/or data services, to mobile communication devices 103a, 103b, and 103c of a plurality of subscribers. The mobile wireless communication network 100 is shown as including two base stations 101a, 101b for purposes of illustration, although the network 100 will generally include many more base stations. Each base station 101a, 101b provides mobile communication services to mobile communication devices located within a respective macro cell having a corresponding cell coverage area 105a, 105b. The cell coverage areas 105a, 105b of adjacent base stations 101a, 101b may overlap with one another (as shown), or may be spaced apart from each other. In general, a macro cell corresponds to a network coverage area that is serviced by a high-power base station 101a, 101b, and therefore has a relatively large coverage area.

The cell coverage areas 105a, 105b are illustratively shown as circular areas surrounding respective base stations 101a, 101b. More generally, however, the cell coverage areas 105a, 105b have complex shapes influenced by local topography, environmental conditions, as well as buildings, walls, and other obstacles that limit the propagation of radio waves between the base stations 101a, 101b and mobile devices 103a, 103b, 103c. In particular, cell coverage areas 105a, 105b often include holes or gaps, sometimes referred to as radio shadow areas, in which no communication services are available or in which only unreliable or low quality communication services are available.

The quality of communication services within a cell coverage area 105a, 105b may vary between different locations in the coverage area, and/or at different times in a same location in the coverage area. In general, however, communication services of reasonable quality are available from an associated base station 101a, 101b within a cell coverage area 105a, 105b. No communication services, or unreliable or low quality communication services, are generally available from a base station 101a, 101b outside of the corresponding cell coverage area 105a, 105b.

Each base station 101a, 101b may correspond to an eNodeB, and may include communication circuitry as well as one or more antennas used for establishing and communicating across wireless communication links with mobile communication devices 103a, 103b, 103c. The base stations 101a, 101b are connected through wired communication links to a backbone network to enable a mobile device connected to a first base station to communicate via the first base station with a mobile device connected to another base station through the backbone network, and/or to enable the mobile device to access mobile communication network services including data services and Internet-based services through the backbone network.

In addition to base stations 101a, 101b providing network communication services in macro cells, the mobile wireless communication network 100 can provide communication services in one or more small cells. A small cell can correspond to a network coverage area that is smaller than a macro cell, and that is serviced by equipment having lower transmit power, lower receive power, and/or lower call processing power than a base station 101a, 101b. A small cell can also be referred to as a pico cell, a femto cell, or a micro cell. The mobile wireless communication network 100 can thus include small cell equipment such as one or more low-power access nodes 107a, 107b. Each access node 107a, 107b provides mobile communication services to mobile communication devices located within a respective small cell having a corresponding small cell coverage area 109a, 109b. In general, the cell coverage area 109a, 109b of a small cell provided by a low-power access node 107a, 107b is smaller than the coverage area 105a, 105b provided by a base station 101a, 101b. Additionally, a low-power access node 107a, 107b is generally operative to provide mobile communication services to no more than a small number of mobile communication devices 103a, 103b, 103c (e.g., fewer than 20 devices), while a base station 101a, 101b is operative to provide mobile communication services to a larger number of mobile communication devices (e.g., 50 or more devices).

The low-power access nodes 107a, 107b are used to extend the range of the mobile wireless communication network 100, and/or to enhance the quality of communication services provided by the network 100 in a location. A low-power access node 107a may thus provide mobile communication network connectivity in an area 109a in which the network 100 does not extend. For example, the low-power access node 107a can provide connectivity in a radio shadow area such as an area located behind a tall building with respect to a base station, an underground area, inside a home or building, or the like. A low-power access node 107b may enhance the quality of communication services in an area 109b in which access to a base station 101b is unreliable, only a slow or low quality communication link with the base station 101b is available, a base station 101b is overloaded by large numbers of communication devices 103b, or the like.

The low-power access nodes 107a, 107b generally connect to the backbone of the mobile wireless network 100 through a wired communication link. For example, a low-power access node 107a, 107b can connect to the backbone network through a dedicated line (e.g., a physical phone line or network cable), through a high-speed Internet connection (e.g., via a cable modem or DSL modem), or the like. In some examples, a low-power access node 107a, 107b connects to the backbone network through a wireless communication link such as a mobile wireless communication link (e.g., in the case of a lower-power access node functioning as a repeater), a WiFi connection, or the like. As in the case of the base stations 101a, 101b, the connection of the low-power access nodes 107a, 107b to the network backbone enable the access nodes to relay communications received directly from mobile devices to the network 100 and/or other devices connected to the network 100, and to receive from the network 100 communications for mobile devices within the corresponding coverage areas 109a, 109b.

In order to maximize the benefits provided by the low-power access nodes 107a, 107b in terms of extending the range of the mobile wireless communication network 100 and enhancing the quality of communication services provided by the network 100, careful consideration is given to selecting locations for installing low-power access nodes 107a, 107b. The selection of locations for installing low-power access nodes 107a, 107b may rely on information on the quality of a wireless communication network services provided at different locations. The selection may further rely on information on current and/or candidate locations in which to install low-power access nodes.

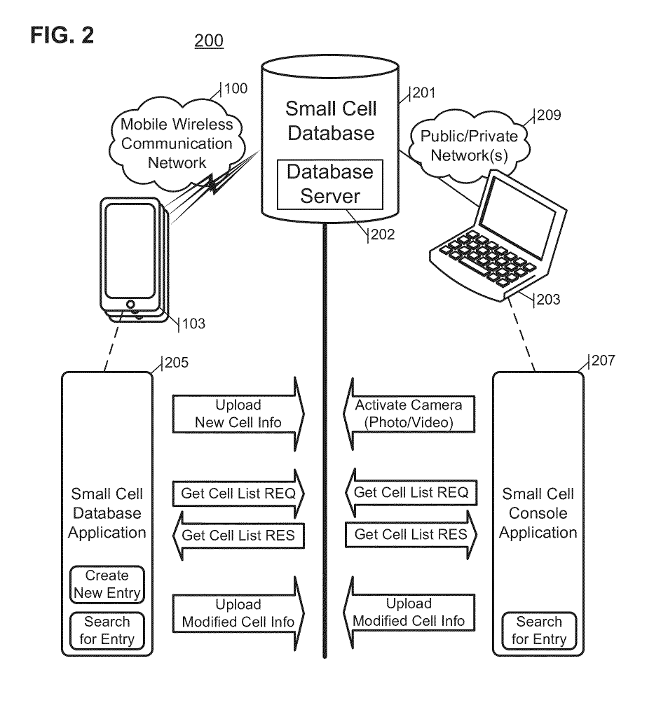

FIG. 2 shows a block diagram of a system 200 for assembling a database 201 of small cell information for use in mobile wireless communication network design and optimization. The small cell information stored in the database 201 includes small cell location information identifying actual and/or candidate locations in which to install low-power access nodes. Specifically, the database 201 stores a plurality of database entries each storing information for a different actual or candidate small cell location.

In the system 200, the database 201 is communicatively coupled to mobile communication devices 103 for example via the mobile wireless communication network 100 and/or other networks (e.g., the backbone network and one or more private networks and public networks such as the Internet). The database 201 can include, in addition to memory storage, a database server 202 that controls communications to/from the database 201, and that provides search, simulation, and other computational functions relating to data stored in the database 201. In some examples, the database server 202 may further execute web applications for providing database-related services such as those described herein to users through web browsers on client devices (e.g., smartphones, personal computers, or the like).

The database 201 is operative to receive small cell information from the mobile communication devices 103, and to provide small cell information to the mobile communication devices 103. In particular, a mobile communication device 103 can execute a small cell database application 205 through which a user of the mobile communication device 103 can interface with the database 201. The user can use the database application 205 to create records corresponding to small cell sites for upload and storage as new database entries in the database 201, for example by selecting a Create New Entry menu option in a user interface of the application 205. The user may further use the database application 205 to generate requests for small cell information, such as a search request for identifying database entries corresponding to small cell sites located in a particular area or matching other search criteria, for example by selecting a Search for Entry menu option in a user interface of the application 205. The database application 205 may receive from the database 201 response messages including small cell information retrieved from database entries matched to the search criteria included in the requests. The small cell database application 205 can further be used to review small cell information stored in and retrieved from the database 201, to correct or otherwise modify the information, and to upload modified small cell information back to the database 201.

The database 201 is further communicatively coupled to one or more console(s) 203 through which console users can interface with the database 201. The database 201 may be coupled to the console 203 through one or more private networks and/or public networks 209 such as the Internet. The console 203 may take the form of any device configured to execute a small cell console application 207, such as a laptop, desktop, or tablet computer, a server, or any other appropriate device. In some examples, the database server 202 can include a user interface and serve as a console.

The console application 207 is operative to generate request messages for small cell information, and to transmit the requests to the database 201 or database server 202. A user can for example select a Search for Entry menu option in a user interface of the application 207 in order to access an interface for searching for database entries. The console application 207 can receive from the database 201 response messages including database entries storing small cell information matching search criteria included in the requests. The small cell console application 207 can further be used to review small cell information received from the database 201, to revise, update, or otherwise modify the information, and to upload modified small cell information to the database 201 for storage in associated database entries. Additionally, the console application 207 can include additional features, such as features for controlling a camera of a mobile device 103 executing the small cell database application 205. In one example, a user of a console 203 executing the console application 207 can thus control the camera of a mobile device 103 to activate the camera and capture photo and/or video images. The captured images can be included in an entry of the database 201.

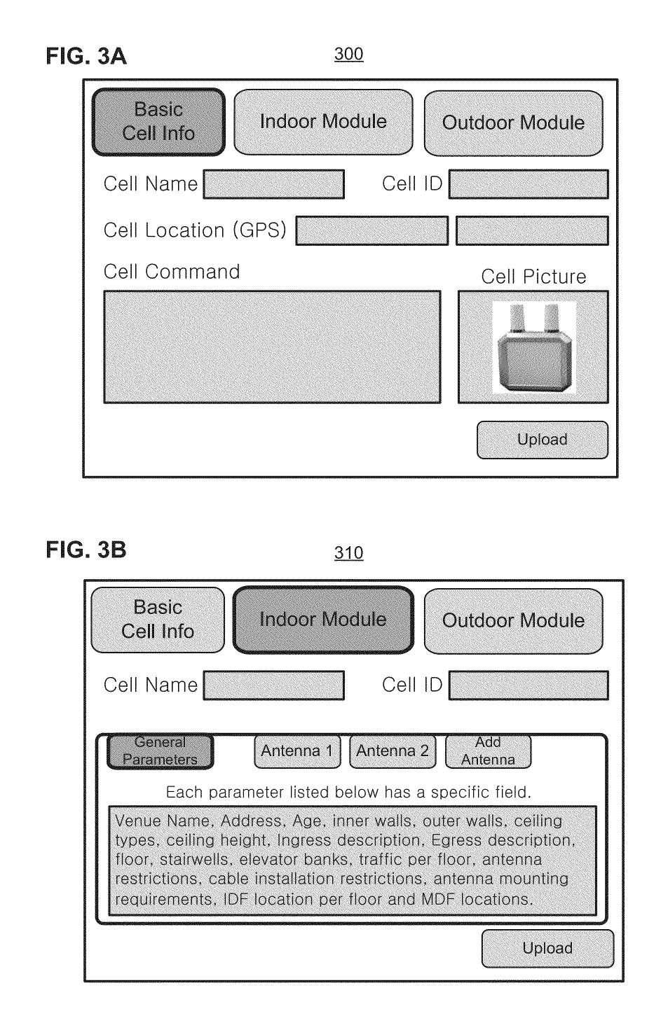

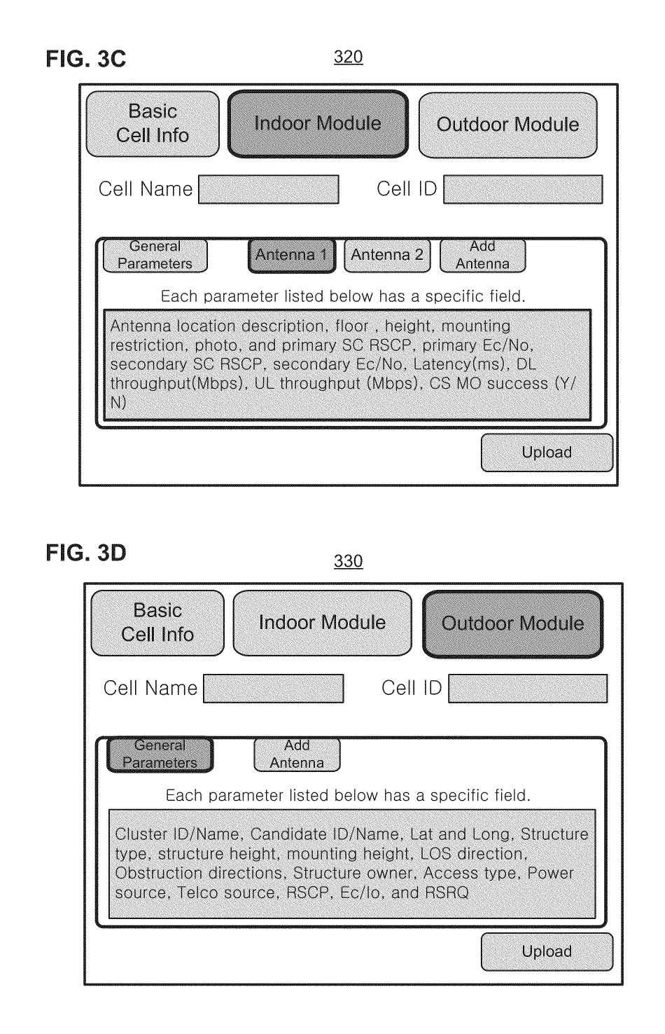

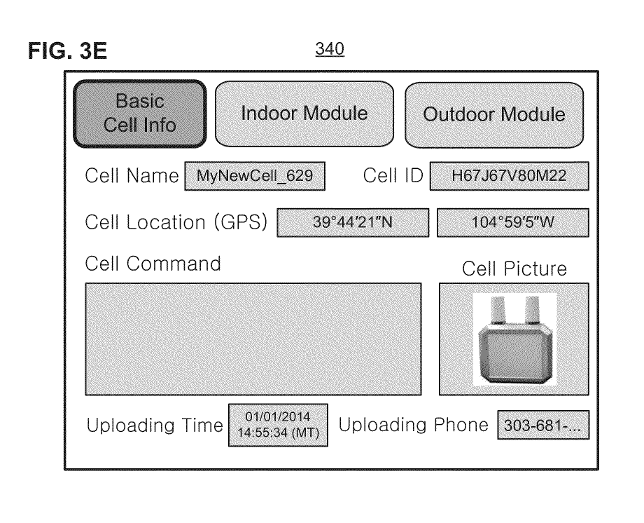

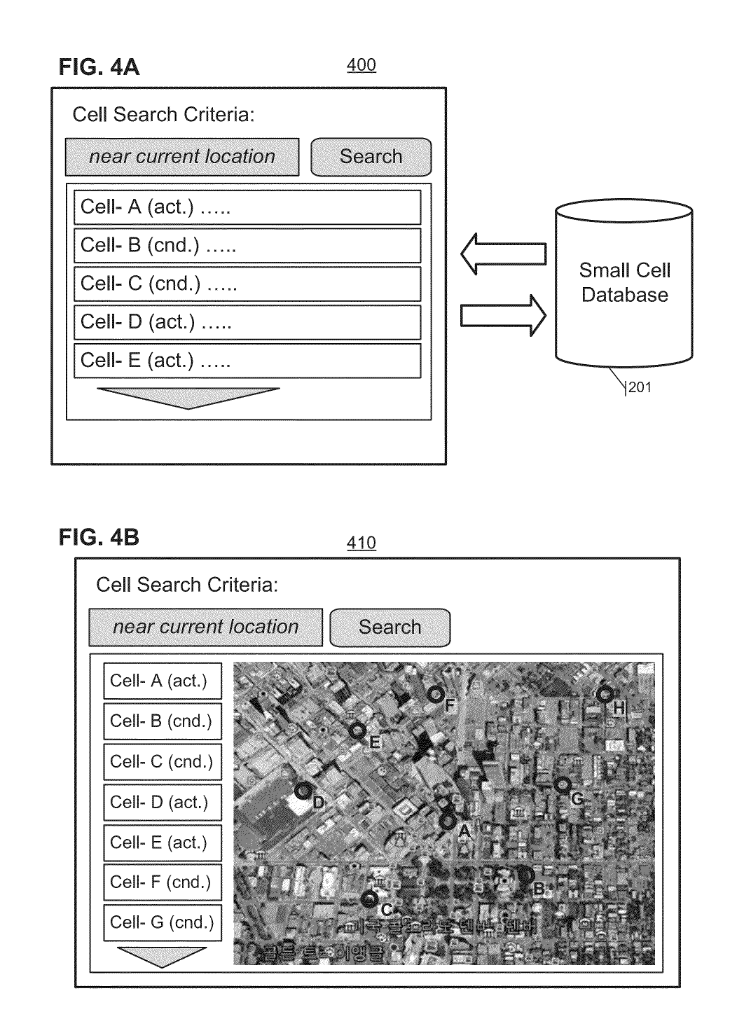

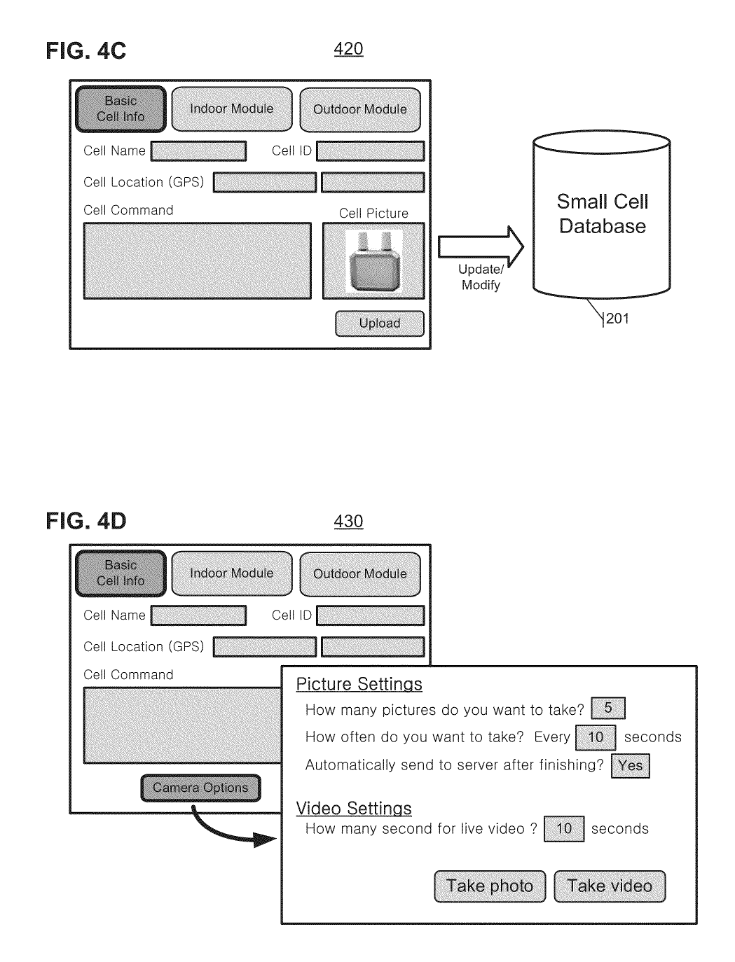

Further features of the database 201 and of the small cell database and console applications 205, 207 executing on the mobile communication devices 103 and/or console(s) 203 is provided below in relation to FIGS. 3A-3E and FIGS. 4A-4D.

FIGS. 3A-3E are screenshots illustrating the operation of the database application 205 executing on a mobile communication device 103 during the creation of a new database entry. The small cell database application 205 is operative to gather information on candidate small cell locations and on actual small cell locations, and to upload the gathered information through a mobile communication network 100 to a small cell information database 201.

In the screenshot 300 of FIG. 3A, a user of the application 205 can create a new database entry for a candidate small cell location or on actual small cell location. As part of creating the new database entry, the database application gathers basic cell information using various systems of the mobile communication device 103. The screen shown at 300 shows some of the elements of basic cell information that are gathered.

The database application 205 may automatically obtain some of the basic cell information, and may populate several of the fields shown at 300 with the automatically obtained information. For example, the application may automatically obtain an identifier for the macro cell and/or a sector of the macro cell that the mobile communication device 103 is currently located in and other mobile communication network connectivity information (e.g., by retrieving macro cell information such as a primary scrambling code (PSC) or a secondary scrambling code (SSC) from a chipset of the device 103), and may populate a Cell Name field, a Cell ID field, and/or other appropriate fields with the obtained information. The application may further automatically obtain a location of the mobile communication device 103, for example by accessing a location determination system or GPS circuitry of the device 103, and may populate a Cell Location field with the obtained information. The user may edit, delete, or replace any of the information that is automatically obtained by the application by selecting a field (e.g., a field shown in screenshot 300), and by providing corrected information.

Some of the fields of information gathered by the database application 205 may not be automatically populated. A user of the application can therefore manually provide information to complete the fields. The user may provide the additional small cell information through the interface of the application, for example by typing or dictating information using a keyboard or microphone of the mobile communication device 103.

In the example of FIG. 3A, in the case of a candidate location, the user may include one or more pictures of a candidate mounting location for an access node or other small cell equipment, and/or of an environment surrounding the candidate mounting location (e.g., showing lines of sight from the mounting location, obstructions surrounding the location, or the like). In the case of an actual small cell location, the user may include one or more pictures of currently installed small cell equipment, as well as pictures of the environment surrounding the equipment. Upon receipt of the pictures from the mobile communication device 103, the database server 202 may optionally process the pictures to obtain additional information on the small cell locations associated with the pictures. In one example, the database server 202 can process a picture of installed small cell equipment to retrieve an equipment model number, serial number, or other identifier so as to automatically identify the equipment shown in the picture. The model number and/or serial number are then stored in the corresponding database entry.

In examples in which one or more pictures are captured using the camera of the mobile communication device 103, the pictures may be captured and stored in association with location and/or orientation information. The orientation information can be obtained from one or more of a compass, an accelerometer, or another system of the mobile communication device 103 that identifies an orientation of the mobile communication device 103 when a picture is taken. The orientation information is used to automatically determine the location of equipment or of a candidate small cell location, and to automatically determine the direction in which each picture of the environment surrounding the location is taken (e.g., picture taken facing west from the candidate location). In general, pictures of candidate mounting locations can be used to determine whether the candidate mounting location can accommodate a certain type of equipment, to identify mounting hardware to supply to install equipment, or the like. Location and orientation information may help a user ascertain whether the mounting location is a wall-mount location, a ceiling-mount location, or the like, and/or to ascertain precisely where the mounting location is located. In the case of pictures of an environment surrounding a candidate mounting location, the pictures can be used to determine the presence of and identify characteristics of obstacles surrounding the mounting location and that may affect the propagation of radio waves to/from equipment installed at the location. The location and orientation information may help the user ascertain a direction in which an obstacle is located relative to the candidate location, for example.

In addition to the basic cell information gathered through the screen shown in FIG. 3A, the database application 205 gathers more detailed information through one or more additional application screens such as those shown in FIGS. 3B-3E. For instance, in the screenshot 310 of FIG. 3B, the user of the application can provide information on an indoor module of the candidate small cell location or of the actual small cell location for which information was provided in screenshot 300. In particular, the user can select a General Parameters tab displayed on the screen, and provide in various entry fields information on any of a venue, communication network connectivity, or the like. For example, information can be provided on a venue name (e.g., name of building or other venue, and/or of office or suite within the building, in which the candidate or actual location is located) and venue address; characteristics of a building's construction (e.g., an age of construction; the type and/or materials of inner walls (e.g., concrete, glass, plaster board, wood, or the like); the type and/or materials of outer walls (e.g., brick, concrete, steel, glass, or the like); the type and/or materials of ceiling (e.g., plasterboard, movable foam tiles, unfinished, or the like); a ceiling height; a description of ingress(es) and/or egress(es); the type and/or materials of floor (e.g., concrete, tile, carpet, hardwood, or the like); a presence and proximity to stairwells; a presence and proximity to elevator banks); an estimate of traffic per floor (e.g., 50 employee offices, 5 conference rooms with total capacity for 150 people, reception area with 10 visitors per hour, or the like); restrictions on antenna types, antenna size, or antenna installation (e.g., maximum 6 inches of clearance for mounting); cable installation restrictions; antenna mounting requirements; or the like. Additionally, information can be provided to identify any intermediate distribution frame (IDF) locations and main distribution frame (MDF) locations in proximity to (e.g., on the same floor as) the candidate or actual location and that can be used to interconnect small cell equipment installed at the location to other IDFs, MDFs, and the network 100.

An indoor module (and an outdoor module) can include multiple antennas installed at different locations within a venue. As such, in addition to the general parameters identified in screenshot 310, the user can provide information on multiple antenna locations through the database application 205 by selecting a tab corresponding to an antenna location (e.g., Antenna 1 or Antenna 2), or selecting a button to add information on an additional antenna location. The screenshot 320 of FIG. 3C shows the application interface screen shown to the user in response to selecting the Antenna 1 tab. Using the application interface shown at 320, the user can provide in information on an antenna location including an antenna location description, a floor number, height information, information on any mounting restriction, and one or more photos. The entry fields can further include information on installed equipment and/or measured network connectivity performance at the location, including operational parameters such measures of signal strength, noise and interference, path loss, or the like. In the xample shown in FIG. 3C, the entry fields include fields relating to a primary scrambling code (SC) received signal code power (RSCP) (e.g., in universal mobile telecommunication systems (UMTS) systems); a primary ratio of a received energy per chip (Ec) of the pilot channel to the total noise power density (No) (Ec/No), secondary SC RSCP, secondary Ec/No, latency (in milliseconds (ms)), downlink (DL) throughput (in bits per second (bps)), uplink (UL) throughput (in bps), and call setup (CS) success for mobile originated (MO) calls (Y/N).

Alternatively or additionally to providing information on an indoor module, the user of the database application 205 can provide information on outdoor modules of the candidate small cell location or of the actual small cell location for which information was provided in screenshot 300, as shown in screenshot 330 of FIG. 3D. The user can select the Outdoor Module tab, followed by a General Parameters tab displayed on the screen, and provide information relating to the outdoor module's general parameters in various entry fields. For example, the user may provide information on a Cluster ID/Name and/or Candidate ID/Name that the outdoor module is associated with; a latitude and longitude position of the outdoor module; information on a structure type, a structure height, and a mounting height at which the outdoor module is mounted; line of sight (LOS) direction (e.g., direction of a direct free-space path from the location, in which there are no obstructions); one or more directions in which obstructions are located; identification of an owner of the structure on which the module is mounted, as well as information on access type, power source, and network connectivity available for the module; and information on RSCP, Ec/Io, reference signal received power (RSRP) or signal strength and reference signal received quality (RSRQ); received signal strength indicator (RSSI); or the like. The outdoor module may further have one or more antennas associated therewith, and information on such antenna(s) can be provided through interface similar to that shown in FIG. 3C.

The information gathered by the small cell database application is uploaded from the mobile communication device 103 to the database 201 for storage in a database entry, either automatically or in response to a user selection of an upload button. Once uploaded, the small cell location information can be retrieved or processed to identify a set of optimal locations for installing additional equipment. The set of optimal locations can be identified, for example, through a series of simulations that are based on the small cell information stored in the database and that are used to estimate the network coverage provided by additional equipment installed at locations identified in the database. In this respect, screenshot 340 of FIG. 3E shows a database entry retrieved from the database 201 using the database application 205. The record of FIG. 3E shows the information stored with the database entry, including the information described in relation to screenshots 300-330 above. Additionally, a time at which the last information was uploaded, and identification of a phone or mobile communication device from which the information was uploaded, can be included in the record. The mobile communication device may be identified by a mobile device number (MDN), a mobile equipment identifier (e.g., MEID) or serial number, or the like.

The information stored in the small cell database 201 can thus be retrieved by a user of the database application 205, or a user of the console application 207, in order to obtain more information on a particular small cell location. In one example, a user can thus obtain information on actual and/or candidate locations in a particular area, and can use the information to determine where additional small cell equipment can be installed to improve network quality. In some examples, the applications 205, 207 can run simulations based on the small cell information stored in the database 201 to determine the expected performance of the network at various locations under the assumption that small cell equipment is installed in, and/or removed from, selected locations. The simulations can include propagation models used to model the propagation of electromagnetic waves from actual and candidate small cells and macro cells, and predict the network coverage provided by the cells at various locations. While the simulations can be run on the user mobile device 103 and/or the console 203, the simulations are generally computationally expensive and are executed by the database server 202 based on user selections received through an application 205, 207. The results of the simulation are then communicated back to the application 205, 207 for presentation to the user. The user may further use the database to simulate the expected performance of the network at various locations under different load conditions (e.g., when large numbers of mobile communication devices are located at the locations and use network resources), based on the information on actual and stored locations of equipment stored in the database 201 and on electromagnetic wave propagation models.

FIGS. 4A-4D are screenshots illustrating the operation of the database application 205 executing on a mobile communication device 103, and/or of the console application 207 executing on a console 203, during the retrieval of information from the database 201. The database and console applications are operative to retrieve information relating to candidate small cell locations and to actual small cell locations from the database 201, and to update or modify information stored in the information database.

As shown in FIG. 4A, a user of the application 205, 207 can retrieve information from the database 201. The application 205, 207 provides a user interface screen 400 for searching for small cell information stored in the database. A user can thus provide one or more search criteria for identifying database entries matching the search criteria, wherein the search criteria can relate to any of the information stored in the database (such as any of the information described above in relation to FIGS. 3A-3E).

In the illustrative example shown in FIG. 4A, the user has entered a location-based search criteria in the search field. In response to the user entering the search criteria, the application 205, 207 generates and transmits to the database 201a request for database entries matching the search criteria. In the illustrative example, the generating of the request includes determining a current location of the mobile communication device 103 in which the request is generated, and providing the determined location in the request. In response to transmitting the request to the database 201, the database 201 and/or a database server 202 associated with the database searches for entries matching the criteria, and returns a response message to the application 205, 207 including those database entries matching the criteria. In the illustrative example, database entries corresponding to a Cell-A, a Cell-B, a Cell-C, a Cell-D, and a Cell-E are determined to match the location-based search criteria, and are displayed by the application as part of the screenshot 400. In the illustrative example, each database entry determined to match the search criteria may be identified as either an actual (act.) location of small cell equipment, or a candidate (cnd.) location of small cell equipment, to enable the user to quickly ascertain which type of location each search result corresponds to. In some examples, the user is able to restrict the search results to only identify actual locations or to only identify candidate locations that match the search criteria.

In other examples, the user may enter other search criteria in the application 205, 207, such as a macro cell identifier (Cell ID), a cell name, an address, a venue name, an equipment type, or the like. The application 205, 207 then obtains database entries matching the search criteria from the database 201, and displays the obtained entries to the user.

In some examples, the application is configured to provide a graphical presentation of search results such as a map of search results. For example, screenshot 410 of FIG. 4B shows results of a search for small cell database entries that are presented on a map. Each search result is indicated by an identifier on the map, and may additionally be listed next to the map.

A user of the application 205, 207 may select any search result identified on the map and/or in the list in order to view more detailed information on the search result. For example, in response to selecting one of the search results shown in FIG. 4A or in FIG. 4B, the application 205, 207 can display an interface screen such as that shown in screenshot 420. In the screenshot 420, the user may select any of the tabs Basic Cell Info, Indoor Module, or Outdoor Module to obtain more information from the database entry. The user may further modify any of the information displayed, and may select the Upload button in order to replace the information stored in the database 201 with updated or modified information. In response to selecting the Upload button, the application 205, 207 generates and transmits to the database 201 a database update message identifying the database entry to be updated and including the updated information.

The application 205, 207 may additionally be operative to display both small cells matching a search criteria and macro cells matching the search criteria, such that both information on small cells and information on macro cells can be accessed from the search results display. In such examples, the database 201 may be expandable and store information on macro cells, and the database may be configured to return to the applications 205, 207 information on macro cells matching search criteria received from the applications. Alternatively, the database 201 or the applications 205, 207 may be operative to communicate with a macro cell database (not shown) that is separate from the small cell database 201 to obtain information on macro cells matching search criteria.

The console application 207 can further be configured to receive information from the database 201 in real time (e.g., in real time or in near real time) when new information is received in the database 201. Specifically, the console application 207 may generate and transmit to the database 201a request for real time updated from the database 201. In response to receiving the request, the database 201 automatically transmits to the console 203 executing the console application 207 new database entries and/or database entries for which updated information is received when new entries or updates to entries are received. The database 201 may automatically transmit the entries in real time such that a user of the console 203 can monitor new database entries at substantially the same time as a field technician is creating the entries in the field (e.g., while the field technician is located at or near the location of a corresponding actual or candidate location of a small cell). In response to receiving a real time database update, the console application 207 automatically displays the received database entry. The interface displaying such an entry may be substantially similar to screenshot 420, and may enable the user of the console application 207 to provide oversight of the work performed by the field technician in real time. The interface of console application 207 that displays the database entry can be substantially similar to the interface of the database application 205 (e.g., as shown in FIG. 4C), or can be different from the interface of the database application 205. A user of the console application 207 can selectively adjust the interface and the information displayed therein for the convenience of the user.

The console application 207 may further be used to remotely control a user mobile communication device 103. For example, screenshot 430 of FIG. 4D shows a user interface screen from the console application 207 used to remotely control a user mobile communication device 103. As shown in FIG. 4D, the console application 207 may include a Camera Options button when displaying information obtained from a database entry. In particular, the Camera Options button may be provided by the console application 207 when the application is displaying information received in real time from the database 201 and from a user mobile communication device 103. Various options other than the Camera Options may be displayed in the console application 207.

In response to selecting the Camera Options button, the console application 207 provides the user with various options for controlling the user mobile communication device 103. In the example, the user of the console application may select a number of pictures to be taken with a camera of the user mobile communication device 103, a time period (e.g., a time interval) between pictures, and an option to have pictures automatically uploaded to the database server 201. The user of the console application may alternatively or additionally control the camera to capture video, and may include an option to select a time period for video length. In response to the user selecting the Take Photo or the Take Video option, a control command is generated by the console application 207 and transmitted to the database 201. The control command includes an instruction to cause the database application 205 executing on the mobile communication device 103 having provided the real time database entry information to capture a photo or video image.

In response to receiving the control command, the database 201 identifies the user mobile communication device 103 to which the command should be transmitted, and forwards the command to the identified device 103. In turn, in response to receiving the command, the database application 205 executing on the mobile communication device 103 controls the camera of the mobile communication device 103 to capture the photo or video image. The database application 205 may notify the user of the mobile communication device 103 that a photo or video image is being captured. Optionally, the database application 205 may notify the user of the mobile communication device 103 of the subject matter which should be captured in the image(s), such as to obtain picture(s) of the cell location, of a surrounding environment of the cell location, and/or of small cell equipment.

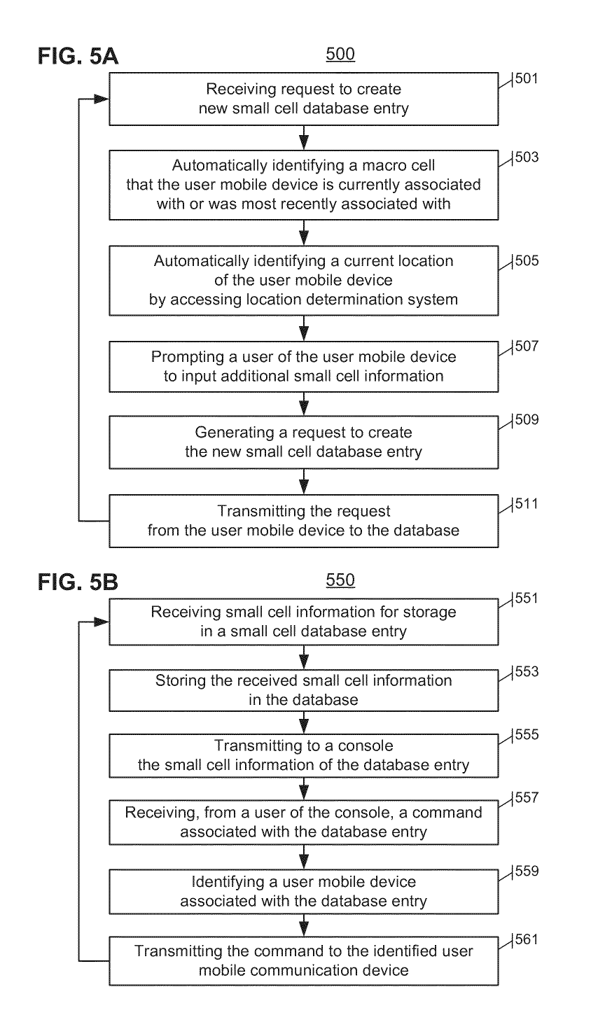

FIGS. 5A and 5B are flow diagrams illustrating steps performed by the database 201, and by a user mobile communication device 103 and/or a console 203, in assembling and using the database. The method 500 of FIG. 5A focuses on the creation of a new database entry, while the method 550 of FIG. 5B focuses on the transmitting of a command from a console 203 to a user mobile communication device 103.

Method 500 begins with the database application 205 executing on the user mobile communication device 103 receiving a request to create a new database entry for storing small cell information in step 501. The request is generally received from a user of the device 103 selecting a menu option for creating a new database entry through the database application 205 executing on the device 103. In some examples, however, the request is received from the database 201, for example in a communication transmitted to the device 103 through the mobile wireless communication network 100.

In response to receiving the request in step 501, the database application 205 automatically obtains certain information to include in the database entry. For example, in step 503, the database application 205 automatically identifies a macro cell of the mobile wireless communication network 100 that the user mobile communication device 103 is currently associated with or, in situations in which the device 103 is not currently connected to the network 100, was most recently associated with. The database application can additionally automatically identify a current location of the user mobile communication device 103 in step 505, for example by accessing a location determination system of the device 103. The macro cell information, the location information, and/or any other information automatically obtained by the database application is automatically populated in the new database entry. A user of the device 103 can optionally edit the automatically populated information if corrections or updates are needed. In addition, the user is prompted for input of additional information to store in the new database entry in step 507. The additional information can include any information that is not automatically populated into the entry, and which relates to the new database entry being created. For example, the additional information can include any of the information described in relation to FIGS. 3B-3D above, including a picture stored in a memory of the device 103 and/or obtained using a camera of the device 103.

When the user has finished entering small cell information in steps 503-507, the user selects an Upload button to cause the database application 205 to generate a request to create the new database entry in step 509. The request includes macro cell information, the location information, and/or any other information automatically obtained by the database application. The request further includes any corrections or updates made by the user, and any additional information provided by the user. Once generated, the request is transmitted from the mobile communication device 103 to the database 201 in step 511, and is stored as a new entry in the database 201. Once the entry is stored in the database 201, the entry can be searched and retrieved by any database application 205 or console application 207 having access to the database. Further, once the request is transmitted in step 511, the database application 205 may return to step 501 to create a next database entry.

Method 550 of FIG. 5B begins with the database 201 receiving small cell information for storage in a small cell database entry. The small cell information can be received as part of a request for creating a new database entry received from a database application 205 executing on a mobile communication device 103, such as the request of steps 509 and 511. The small cell information can more generally be received as part of a request to update, modify, or correct a database entry received from a mobile communication device 103 or from a console 203.

In response to receiving the small cell information, the database server 202 stores the received small cell information in a database entry in step 553. In situations in which the small cell information is received as part of a request to create a new database entry, the server 202 creates the new database entry and stores the small cell information in the new database entry. In situations in which the small cell information is received as part of a request to update, modify, or correct a database entry, the server 202 locates the corresponding database entry and updates or overwrites the corresponding database entry with the received small cell information.

In response to receiving the small cell information, the database server 202 can in some situations generate and transmit to a console 203 a communication including the received small cell information in step 555. For example, if the console 203 has requested that the database server 202 transmit information received from user mobile communication devices in real time (or near real time), the database server 202 may automatically transmit the received information in real time (or near real time) upon receipt of the information. The database server 202 may transmit the information received in step 551, and/or the information stored in the database entry associated with the information received in step 551.

Following the transmitting of the small cell information in step 555, the database server 202 may receive a command from a user of the console 203 in step 557. The command generally identifies a small cell database entry (e.g., the small cell database entry associated with the information transmitted in step 555). In one example, the command is an update or modification to the received small cell information. In the one example, the database server 202 can update a corresponding entry of the database 201 in response to receiving the update or modification. In another example, the command is a control command to obtain a picture or video image to associate with the database entry. In both examples, the database server 202 identifies the user mobile communication device associated with the command in step 559, and forwards the command to the identified user mobile communication device 103 across the mobile wireless communication network 100 in step 561. The database server 202 may identify the user mobile communication device associated with the command based on an identifier for the device included in the information transmitted by the server 202 at step 555 and included in the command received by the server at step 557. The database server 202 may further identify the user mobile communication device associated with the command by retrieving a database entry associated with and identified in the information transmitted by the server 202 at step 555 and included in the command received by the server at step 557, and determining the device identified in the retrieved database entry.

The transmitting of the command to the identified user mobile communication device in step 561 may cause the mobile communication device to generate an update or modification to information associated with a database entry. For example, in situations in which the command is an update or modification to an entry, a user of the mobile communication device may provide a further update or modification to the entry in response to receiving the update of step 561. As such, following completion of step 561, the database server 202 may receive the further update to the database entry from the user mobile communication device, and may update the database to store the modified information. In situations in which the command is a control command to obtain a picture or video image to associate with the database entry, the database server 202 may receive the obtained picture or video image from the user mobile communication device, and may store the received picture or video in the database in association with the appropriate database entry. In both situations, the receipt of the updated information may cause control flow to return to step 551.

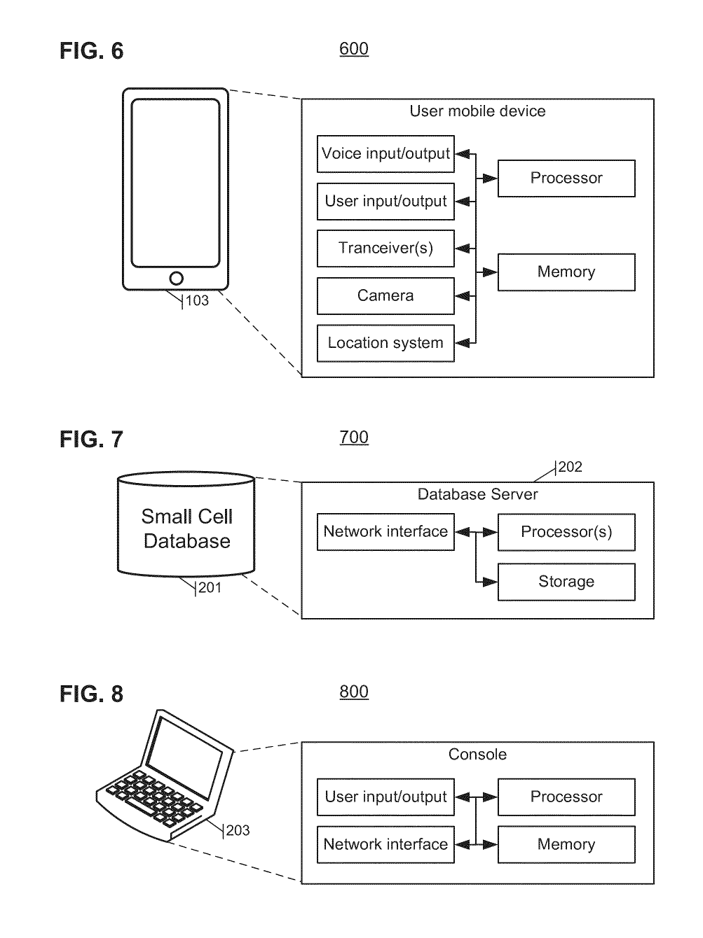

FIGS. 6, 7, and 8 are block diagrams of devices used in the assembly of the database of small cell information as described above. Specifically, FIG. 6 is an illustrative block diagram 600 of a user mobile communication device 103 such as a smartphone; FIG. 7 is an illustrative block diagram 700 of a small cell database 201 including a database server 202; and FIG. 8 is an illustrative block diagram 800 of a console 203.

As shown in the diagram 600 of FIG. 6, a user mobile communication device 103 can include a voice input/output interface including a microphone and a speaker; a user input/output interface including one or more of a keypad, a display, and a touchscreen; one or more transceiver(s) configured for communication across a mobile wireless communication network such as network 100, and optionally additionally configured for communication across other networks such as WiFi wireless networks; a camera for capturing still or video images; and a location determining system to determine a location of the mobile communication device based on a global positioning system (GPS) and signals received from GPS satellites, or on triangulation from base stations having known locations. Operation of the user mobile communication device 103 is controlled by one or more processor(s) coupled to a non-transitory memory storing user data and machine readable instructions for controlling the device.

The database shown at 700 has a non-transitory memory or storage, such as a hard disk drive, for storing the database entries. The database can further include a database server including one or more processor(s) for controlling operation of the database and providing value-added services to users of the database. The database also includes a network communication interface for communicating across one or more different network types, including but not limited to mobile wireless communication networks, local area or wide area networks (LANs/WANs), or the like.

Finally, the console 203 may take the form of a personal computer (as shown in FIG. 8), a network terminal, or the like. The console includes a user input/output interface for presenting information to a user, and receiving selections and commands from the user. The user input/output interface can take the form of a display, mouse or touchpad, touchscreen, and/or keyboard, for example. The console additionally includes a network interface for communicating across one or more different network types, a non-volatile memory storing user data and machine readable instructions, and a processor operative to execute the instructions and control the operation of the console.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method for assembling a database of small cell information for use in design and optimization of a mobile wireless communication network, the method comprising:
receiving, in a user mobile communication device communicatively coupled to the database through the mobile wireless communication network, a request to create a new database entry for storing small cell information, wherein the database stores a plurality of database entries each including small cell information on a location for installing small cell equipment; and
in response to receiving the request, performing steps of:
automatically identifying a macro cell of the mobile wireless communication network that the user mobile communication device is currently associated with or was most recently associated with;
automatically identifying a current location of the user mobile communication device via a location determination system;
prompting a user of the user mobile communication device to input additional information to store in the new database entry and relating to a location for installing small cell equipment; and
transmitting, from the user mobile communication device to the database, the request to create the new database entry storing the identified macro cell, the identified current location, and additional information obtained from the user in response to the prompt.

2. The method of claim 1, wherein the user mobile communication device is a smartphone device.

3. The method of claim 1, wherein the request to create the new database entry is transmitted from the user mobile communication device to the database across the mobile wireless communication network.

4. The method of claim 1, wherein the user mobile communication device executes a database application operative to receive the request to create the new database entry, to automatically identify the macro cell and the current location, and to prompt the user to input the additional information.

5. The method of claim 1, further comprising:
receiving a user selection to include a picture as part of the new database entry; and
in response to receiving the user selection to include the picture, activating a camera of the user mobile communication device, and capturing a picture image using the camera,
wherein transmitting the request to create the new database entry includes transmitting the request to create the new database entry storing the captured picture image.

6. The method of claim 1, wherein prompting the user to input the additional information includes prompting the user for information on construction characteristics of a building including the location for installing small cell equipment.

7. The method of claim 1, wherein the prompting the user to input additional information includes prompting the user for information on a plurality of antenna locations for mounting antennas associated with the location for installing the small cell equipment, and
wherein the plurality of antenna locations correspond to actual or candidate locations for installing antennas.

8. The method of claim 1, further comprising steps of:
transmitting to the database a request for database entries, wherein the request for database entries includes search criteria; and
in response to transmitting the request for database entries, receiving from the database one or more database entries matching the search criteria of the request.

9. The method of claim 8, further comprising:
in response to receiving the one or more database entries matching the search criteria, displaying on the user mobile communication device a map showing the location of each of the received one or more database entries.

10. The method of claim 1, further comprising:
receiving, in the user mobile communication device from the database, a command to capture a picture image or a video image to associate with a database entry;
in response to receiving the command, activating a camera of the user mobile communication device and capturing a picture image or a video image using the camera; and
transmitting the captured picture image or video image to the database for storage in association with the database entry.

11. A method for assembling a database of small cell information for use in mobile communication network design and optimization, the method comprising:
receiving, in a database server storing the database from a user mobile communication device communicatively coupled through the mobile communication network, small cell information for storage in a small cell database entry of the database,
wherein the small cell information includes information on a location for installing small cell equipment;
in response to the receiving of the small cell information, performing steps of:
storing the received small cell information in the small cell database entry of the database;
transmitting from the database server to a console communicatively coupled to the database server, a communication including the small cell information of the small cell database entry; and
receiving, in the database server from the console, a command from a user of the console, wherein the command is associated with the small cell database entry; and
in response to receiving the command, performing steps of:
identifying a user mobile communication device associated with the small cell database entry; and
forwarding the command from the database server to the identified user mobile communication device associated with the small cell database entry.

12. The method of claim 11, wherein the command received from a user of the console is a command to update a small cell database entry.

13. The method of claim 11, wherein the command received from the user of the console is a command to cause the user mobile communication device associated with the small cell database entry to capture a picture image or a video image to associate with the small cell database entry.

14. The method of claim 13, wherein the command to cause the user mobile communication device to capture the picture image or the video image includes a user selection of a time period associated with the capturing of the picture image or the video image.

15. The method of claim 11, further comprising:
receiving from the identified mobile communication device, in response to the forwarding of the command, updated information associated with the small cell database entry; and
storing the received updated information in the small cell database entry of the database server.

16. The method of claim 15, wherein the updated information includes a picture image or a video image.

17. The method of claim 11, wherein the transmitting of the small cell information from the database server to the console is performed in real time or near real time following the receiving of the small cell information in the database server.

18. The method of claim 11, wherein the small cell information includes information on an actual or a candidate location for installing small cell equipment.
